(19) United States
(12) Patent Application Publication
(10) Pub. No.: US 2010/0241447 A1
(43) Pub. Date: Sep. 23, 2010

(54) CUSTOMIZATION OF WOUND DRESSING USING RULE-BASED ALGORITHM

(75) Inventors: Oleg Siniaguine, San Carlos, CA (US); Dmitry Krasnov, San Mateo, CA (US); Theo Brower, Mountain View, CA (US); Dmitriy Sinyagin, New York, NY (US)

Correspondence Address: FENWICK & WEST LLP, SILICON VALLEY CENTER, 801 CALIFORNIA STREET, MOUNTAIN VIEW, CA, 94041, US

(73) Assignee: PolyRemedy, Inc., Mountain View, CA (US)

(21) Appl. No.: 12/436,071

(22) Filed: May 5, 2009

Related U.S. Application Data
(63) Continuation-in-part of application No. 12/110,228, filed on Apr. 25, 2008.

(51) Int. Cl. G06Q 50/00; G06Q 99/00; G06Q 10/00

(52) U.S. Cl. 705/2; 705/10

(57) ABSTRACT

A method and/or system for customizing wound dressings based on an effective wound treatment protocol created by collecting and analyzing wound treatment records. The wound treatment records are collected from one or more wound treatment facilities. The wound dressings are not customized for each patient based solely on experiences and knowledge of medical practitioners but also based on the wound treatment protocol. Further, an intuitive and systematic user interface for a wound dressing fabricator is provided to allow medical practitioners with varying levels of experiences and knowledge to customize wound dressings for a specific wound. By using the wound treatment protocol and the systematic user interface, flawed wound dressings are less likely to be fabricated. Various other functionalities are also provided to manage and support the wound dressing fabricator.

### RELATED APPLICATIONS

This application is a continuation-in-part application of patent application Ser. No. 12/110,228 entitled “Wound Care Treatment Service Using Automatic Wound Dressing Fabricator,” filed on Apr. 25, 2008, which is incorporated by reference herein in its entirety.

### BACKGROUND

1. Field of Art

The present invention generally relates to customizing wound dressings, and more specifically, to systematically and optimally customizing wound dressings for a specific wound of a patient.

2. Background of the Invention

Currently, most wounds are treated by covering the wounds with wound dressings. Although some wounds can be treated using generic, prefabricated wound dressings, others need customized wound dressings that include multiple layers of material with different material properties as well as customized shapes and sizes specific to the type, location and configuration of the wound. Typically, a medical practitioner such as a nurse or doctor, first inspects the wound, and then determines based on their personal knowledge, experience, and practice guidelines, the materials, sizes and shapes of wound dressings needed to treat the wound. The practitioner then manually crafts the dressing, first by selecting from an available inventory of standardized dressing supplies, appropriate materials, and then cutting and joining different layers of the materials. The resulting wound dressings are then applied to the wound by the medical practitioners at the wound care clinic. This process thus critically depends on the skill and knowledge of the practitioner as well as what dressing materials happened to be available. If a particular dressing material is not available, then the practitioner must select an alternative, which may be less than satisfactory.

Normally, a patient needs to have the wound dressing replaced on a regular basis, especially for chronic wounds. In order to replace the wound dressings, the patient must either visit the wound care clinic or order components of replacement wound dressings from a wound dressing distributor or a pharmacy. The wound dressing distributors or pharmacy takes up a considerable amount of time preparing kits of standard size wound dressings for each patient. After receiving orders, the wound dressing distributor organizes and sends to the patients or the medical facility a kit of standard wound dressings that typically lasts thirty (30) days, using the same set of materials. Even with the kit of standard dressings, each particular wound dressing must be customized by a clinician or the patient for the specific wound being treated. However, as the wound condition changes during the healing process that may take several months, the provided wound dressings becomes inappropriate for the wound. Therefore, it is preferable to prepare and send the wound dressings to the patients in a smaller batch so that the wound dressings can be adjusted with progress of the wound condition.

The prepared kit of standard wound dressing materials is not suitable for the patients for a number of reasons. These flawed wound dressings result from, among other reasons, (i) inaccurate matching of the wound dressing materials needed as the wound healing progresses, (ii) inappropriate designing of the wound dressings based on existing standard packaging, and (iii) non-compliant preparation of the patient's wound dressing based on the kit of standard packaging sent to the patient. Due to these reasons, it is estimated that up to 80% of the patient's wound dressings using conventional wound treatment system and method are flawed or inappropriate for the wounds at the specific time of treatment. Flawed wound dressings adversely affect the wound healing process and prolong the wound treatment.

### SUMMARY

Embodiments provide a method, an apparatus, a system and/or a computer-readable storage medium for customizing and fabricating a wound dressing adapted to a wound of a patient using a computer implemented, rule-based, wound dressing customization algorithm implementing a clinical protocol for treating wounds. A set of wound parameters is received from a medical practitioner. The set of wound parameters is provided to the rule-based algorithm to generate a wound dressing specification. The wound dressing customization algorithm applies rules representing a clinical protocol to the set of wound parameters and determines dressing parameters to be included in the wound dressing specification. The rules relate different aspects of various wound parameters (e.g., size, shape, type of wound, level of exudation) to different aspects of the dressing parameters (e.g., dimensions, number of layers, types of layers, and so forth). A wound dressing fabricator fabricates the wound dressing according to the wound dressing specification.

The wound dressing specification includes one or more parameters that are determined by the wound dressing customization algorithm. These parameters are not received from the medical practitioner but instead determined from the algorithm based on the set of wound parameters received from the medical practitioner. The number of parameters received from the medical practitioner is varied depending on the access level of the medical practitioner. For medical practitioners with less experience and knowledge, fewer numbers of parameters are presented for selection while determining more numbers of parameters by the algorithm.

To configure the algorithm to generate the wound dressing specification in accordance with a clinical protocol, individual setting parameters for the wound dressing customization algorithm are received manually from the medical practitioner or downloaded by the manufacturer of the wound dressing fabricator as default or recommended values. The setting parameters are referenced by the wound dressing customization algorithm to present options to the medical practitioners or generate the wound dressing specification. The setting parameters, among others, including the following may be set manually: (i) selection as to allow or disallow setting of certain time intervals for changing wound dressings depending on the level of exudate from the wound; (ii) the characteristics of primary and secondary material of the wound dressing for the selected combination of the level of exudate and the time interval for changing the wound dressings; and (iii) selection as to allow or disallow changes to the shape of the selected primary or secondary material of the wound dressing; and (iv) selection as to allow or disallow the use of the selected secondary material of the wound dressing.

Alternatively, the setting parameters of the wound dressing customization algorithm are determined automatically by analyzing wound treatment reports including the results of wound treatments using the customized wound dressings. The wound treatment reports are collected from one or more wound dressing fabricators. Statistical analysis is performed on the wound treatment reports to determine best practices for a category of wounds. Best practices for two or more categories of wounds are combined into updated setting parameters. The updated setting parameters are then sent to the wound dressing for deployment.

A wound dressing fabricator sends a request to fabricate the wound dressing to another wound dressing fabricator when a predetermined event is detected. For example, the wound dressing fabricator sends the request to another wound dressing fabricator when the amount of time for fabricating all the wound dressings exceeds a threshold or material needed for fabricating the wound dressing is exhausted or likely to be exhausted before fabricating all the wound dressings in the queue.

The wound dressing fabricator uses a wound progression model to predict the progress of the wound. When a plurality of wound dressings are to be fabricated in a session, the wound dressing fabricator varies each wound dressing based on the predicted progress of the wound. The wound dressing fabricator may use a dressing progression model to predict the changes of dressing properties if the dressing properties are dependent on the time between the dressing fabrication and the use of dressing. When a plurality of wound dressings are to be fabricated in a session, the wound dressing fabricator varies each wound dressing based on the time that the wound dressing is to be applied to the wound and/or dressing parameters dependent on the storage or shipment of wound dressings. The time dependent dressing parameters include, for example, the following: (a) hydration level of a dressing that changes due to evaporation and loss of fluid lost through packaging; (b) redistribution of fluid or flowable drugs inside the dressing due to diffusion or capillary forces; and (c) change of antimicrobial additives or drugs due to oxidation or temperature.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a functional region diagram illustrating a wound treatment system with wound dressing fabricators installed in a plurality of wound treatment facilities, according to one embodiment.

FIG. 2 is a functional region diagram illustrating a wound dressing fabricator for customizing and fabricating wound dressings, according to one embodiment.

FIG. 3 is a perspective view of a wound dressing fabricator according to one embodiment.

FIG. 4 is a region diagram illustrating a facility manager according to one embodiment.

FIG. 5 is a region diagram illustrating a wound treatment evaluator according to one embodiment.

FIG. 6 is a flow chart illustrating a method of customizing and fabricating a wound dressing, according to one embodiment.

FIG. 7 is a flow chart illustrating a method of customizing a wound dressing in a standardized configuration mode, according to one embodiment.

FIG. 8 is a flow chart illustrating a method of customizing a wound dressing in an customized configuration mode, according to one embodiment.

FIG. 9 is a flow chart illustrating a method of setting parameters for wound dressing customization algorithm, according to one embodiment.

FIG. 10 is a user interface displayed for logging into a wound dressing fabricator, according to one embodiment.

FIG. 11 is a user interface displayed to receive selection of a patient for the current session of a wound dressing fabricator, according to one embodiment.

FIG. 12 is a user interface displayed to receive information for adding a new patient to a wound dressing fabricator, according to one embodiment.

FIG. 13 is a user interface displaying virtual wound cards, according to one embodiment.

FIG. 14 is a user interface displayed to receive the type of a wound, according to one embodiment.

FIG. 15 is a user interface displayed to receive the location of a new wound, according to one embodiment.

FIG. 16 is a user interface displaying possible locations of a pressure wound, according to one embodiment.

FIG. 17 is a user interface displayed to receive parameters in the standardized configuration mode customizing of a wound dressing, according to one embodiment.

FIG. 18 is a user interface displayed to receive wound dressing parameters in the customized configuration mode customizing of a wound dressing, according to one embodiment.

FIG. 19 is a user interface displaying the specification of a customized wound dressing for confirmation, according to one embodiment.

FIG. 20 is a user interface displaying a table associated with the standardized configuration mode, according to one embodiment.

FIG. 21 is a user interface displayed to receive setting parameters associated with an entry in the table of FIG. 20, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

Embodiments provide a method and/or system for customizing wound dressings based on an effective wound treatment protocol created by collecting and analyzing wound treatment records. The wound treatment records are collected from one or more wound treatment facilities. The wound dressings are not customized for each patient based solely on experiences and knowledge of medical practitioners but also based on a computer implemented, rule-based, wound dressing customization algorithm that implements a wound treatment clinical protocol. Further, an intuitive and systematic user interface for a wound dressing fabricator is provided to allow medical practitioners with varying levels of experiences and knowledge to customize wound dressings for a specific wound. By using the wound dressing customization algorithm and the systematic user interface, flawed wound dressings are less likely to be fabricated. Various other functionalities are also provided to manage and support the wound dressing fabricator.

### Architecture of Wound Treatment System

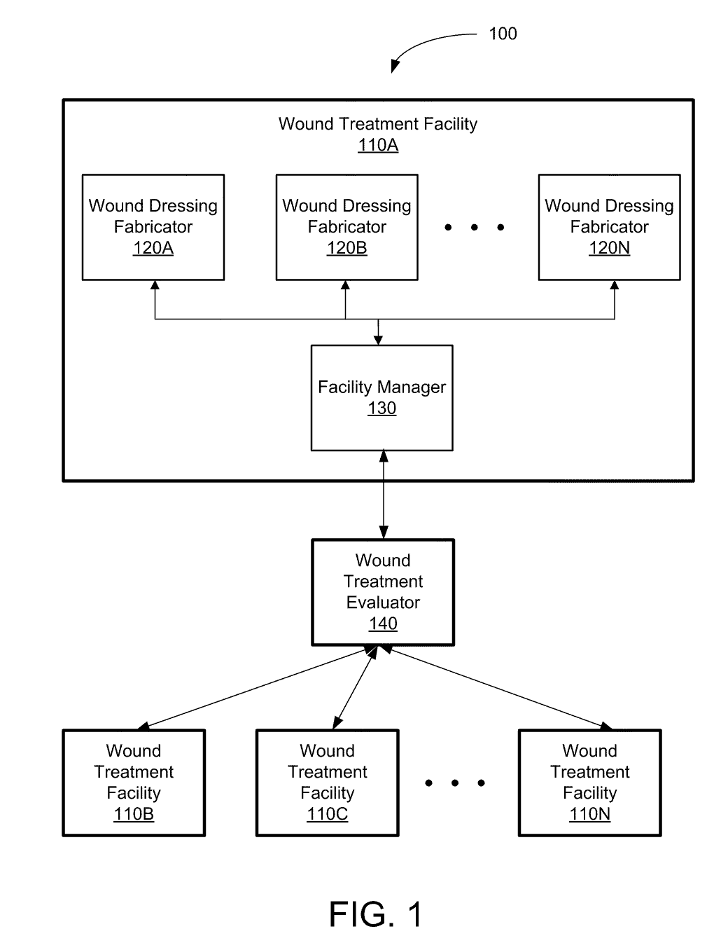

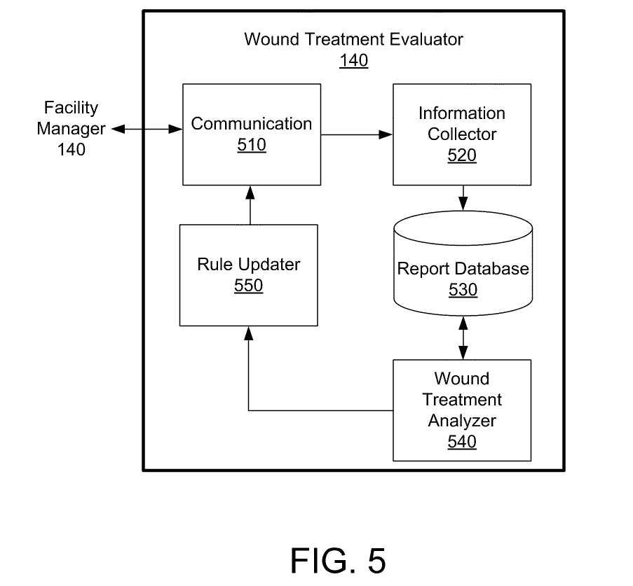

FIG. 1 is a functional region diagram illustrating a wound treatment system 100 according to one embodiment. The wound treatment system 100 includes, among others, wound treatment facilities 110A through 110N (hereinafter, collectively referred to as “the wound treatment facilities 110”) and a wound treatment evaluator 140. The wound treatment facilities 110 may be located at different geographical locations to service different groups of patients. The wound treatment evaluator 140 collects wound treatment information from one or more wound treatment facilities 110 to evaluate and analyze wound treatment reports from wound treatment facilities 110, as described below in detail with reference to FIG. 5.

Each wound treatment facility 110 includes, among other components, one or more wound dressing fabricators 120A through 120N (hereinafter, collectively referred to as “the wound dressing fabricators 120”) and a facility manager 130. The wound dressing fabricators 120 are described, for example, in co-pending U.S. patent application Ser. No. 12/110,228 entitled “Wound Care Treatment Service Using Automatic Wound Dressing Fabricator,” filed on Apr. 25, 2008, which is incorporated by reference herein in its entirety. Further, each wound treatment facility 110 may include one or more wound dressing parameter generators in lieu of or in addition to the wound dressing fabricators 120, as described in the same U.S. Patent Application.

Although the facility manager 130 and the wound treatment evaluator 140 are illustrated as a device distinct from the wound dressing fabricators 120, the facility manager 130 or the wound treatment evaluator 140 may be implemented as part of a wound dressing fabricator 120 as well. Further, the facility manager 130 may be omitted from the wound treatment system 100. That is, the wound dressing fabricators 120 communicates directly with the wound treatment evaluator 140. In embodiments where the wound treatment evaluator 140 is omitted, some or all of the functional components of the wound treatment evaluator 140 are distributed across one or more wound dressing fabricators 120 within the wound treatment facility 110.

### Architecture of Wound Dressing Fabricator

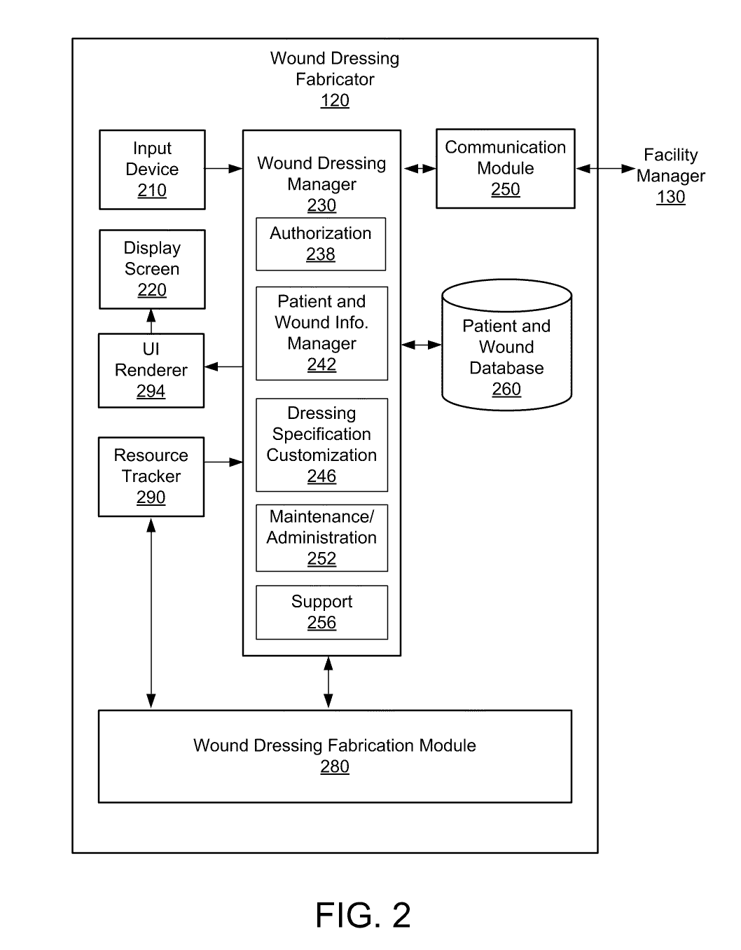

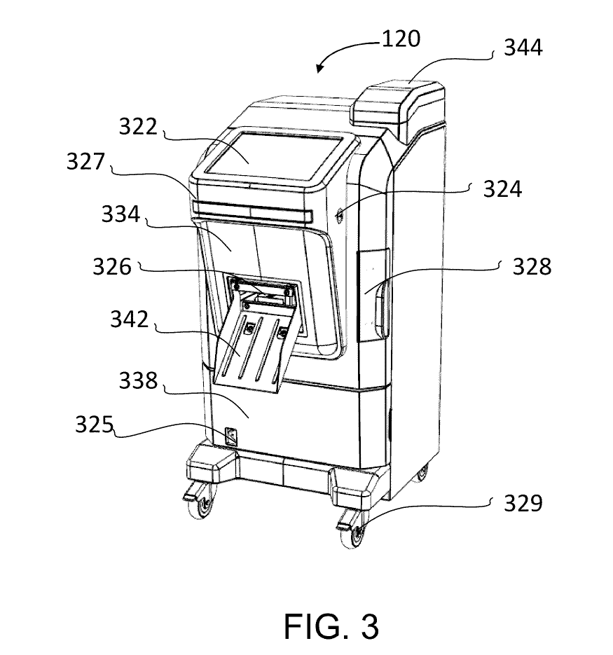

FIG. 2 is a functional region diagram illustrating the wound dressing fabricator 120 for customizing and fabricating the wound dressings, according to one embodiment. The wound dressing fabricator 120 includes, among other components, an input device 210, a display screen 220, a wound dressing manager 230, a communication module 250, a patient and wound database 260, a wound dressing fabrication module 280, a resource tracker 290, and a user interface renderer 294. One or more components of the wound dressing fabricator 120 described herein may be combined into or implemented on a single logical or physical device. Further, one or more of these components, in conjunction with other components, may be implemented in the form of hardware, firmware, software, or any combinations thereof. An illustrative wound dressing fabricator 120 is described below in detail with reference to FIG. 3.

The input device 210 receives user inputs associated with, for example, login information of a user, patient information, wound information, and parameters for customizing the wound dressing. The input device 210 may be implemented as, for example, keyboards, touch screens, keypads, imaging devices and diagnostic devices. Alternatively, The input device may be another remote computer connected to communicate with the dressing manager 230. The input device 210 is coupled to the wound dressing manager 230 to provide various user inputs associated with accessing the wound dressing fabricator 120 and customizing the wound dressing.

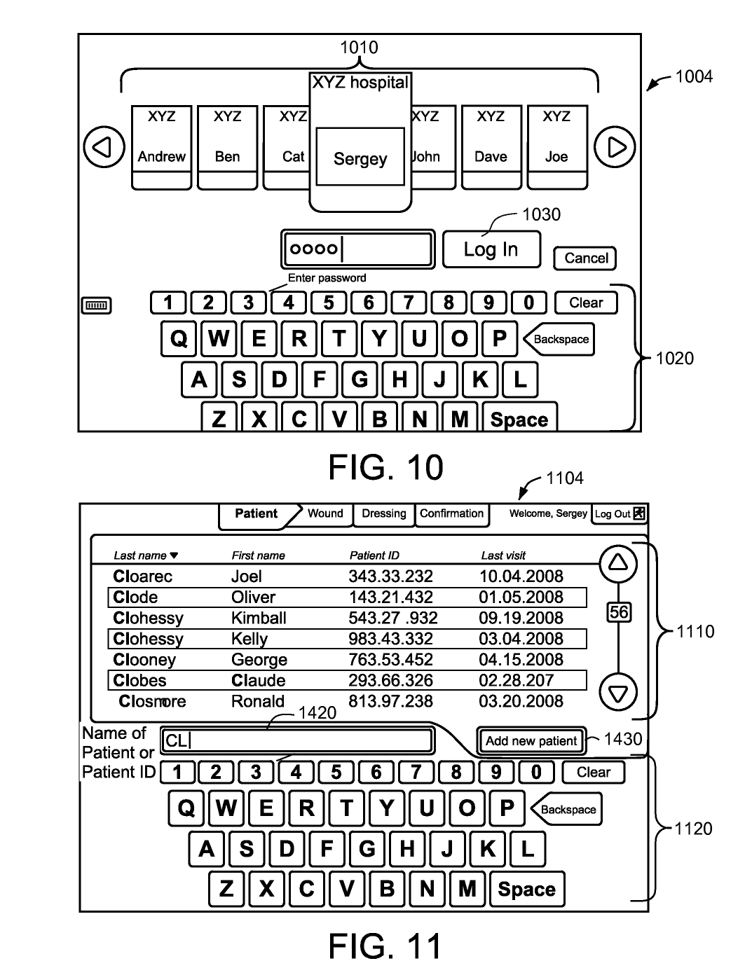

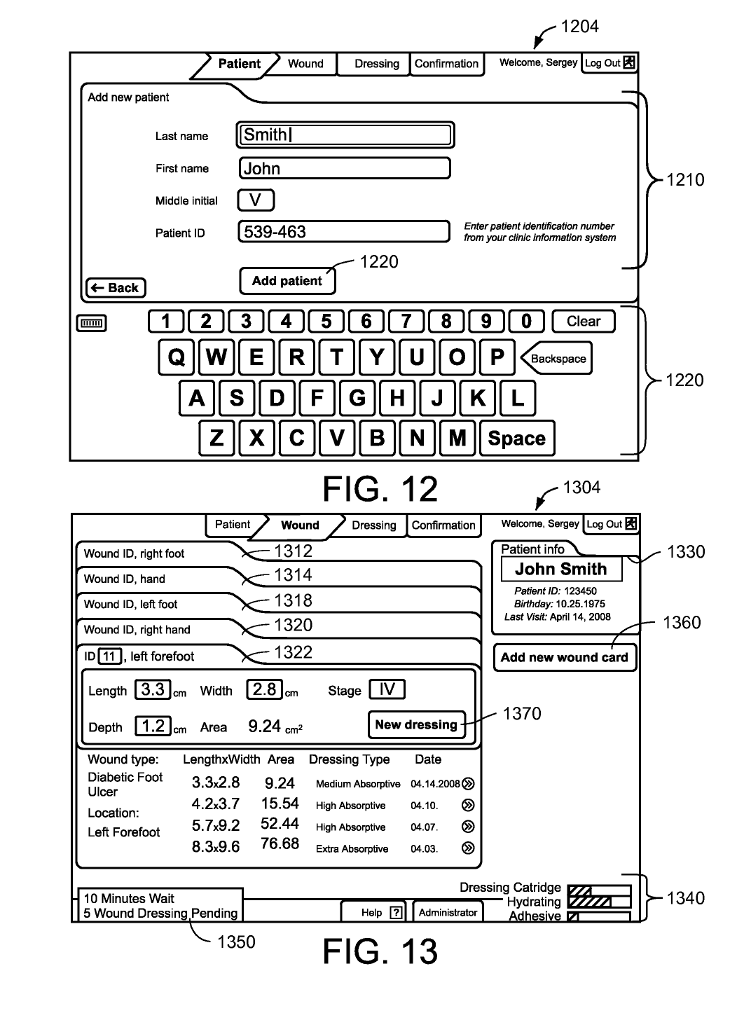

The display screen 220 displays user interfaces as generated by the user interface renderer 294, for example, as described below in detail with reference to FIGS. 10 through 21. If a remote computer is used to provide user inputs, the display screen 220 may be disabled or used for displaying the screen of the remote computer.

The wound dressing manager 230 performs various functions associated with customizing and fabrication of the wound dressing based on user inputs received via the input device 210. The wound dressing manager 230 includes, among others components, an authorization module 238, a patient and wound information manager 242, a dressing customization module 246, a maintenance/administration module 252, and a support module 256. One or more of these components, in conjunction with other components, may be implemented in the form of hardware, firmware, software, or any combinations thereof. Further, one or more components of the wound dressing manager 230 may be removed from the wound dressing fabricator 120 and instead be implemented on the facility manager 130 or other external devices.

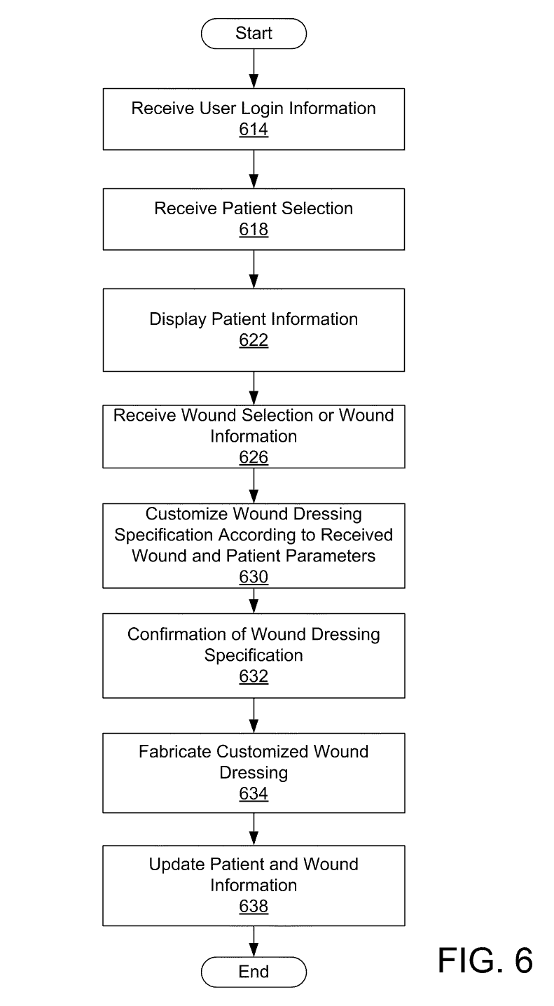

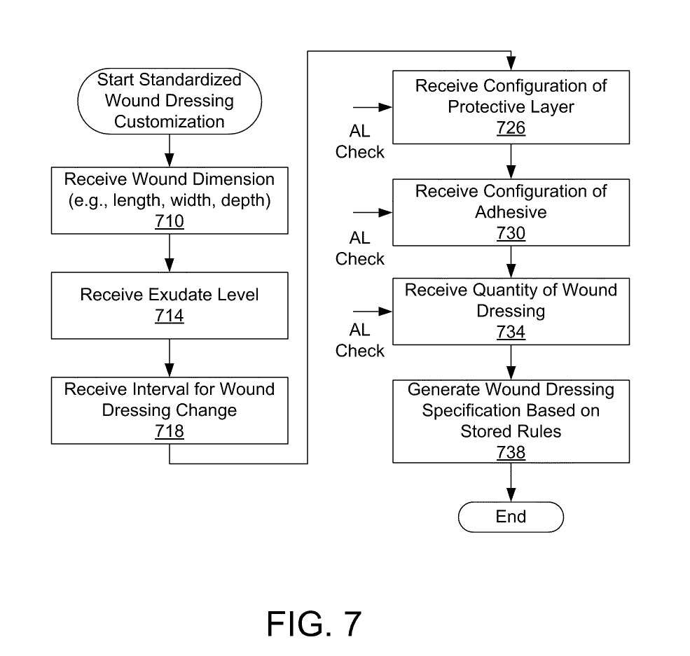

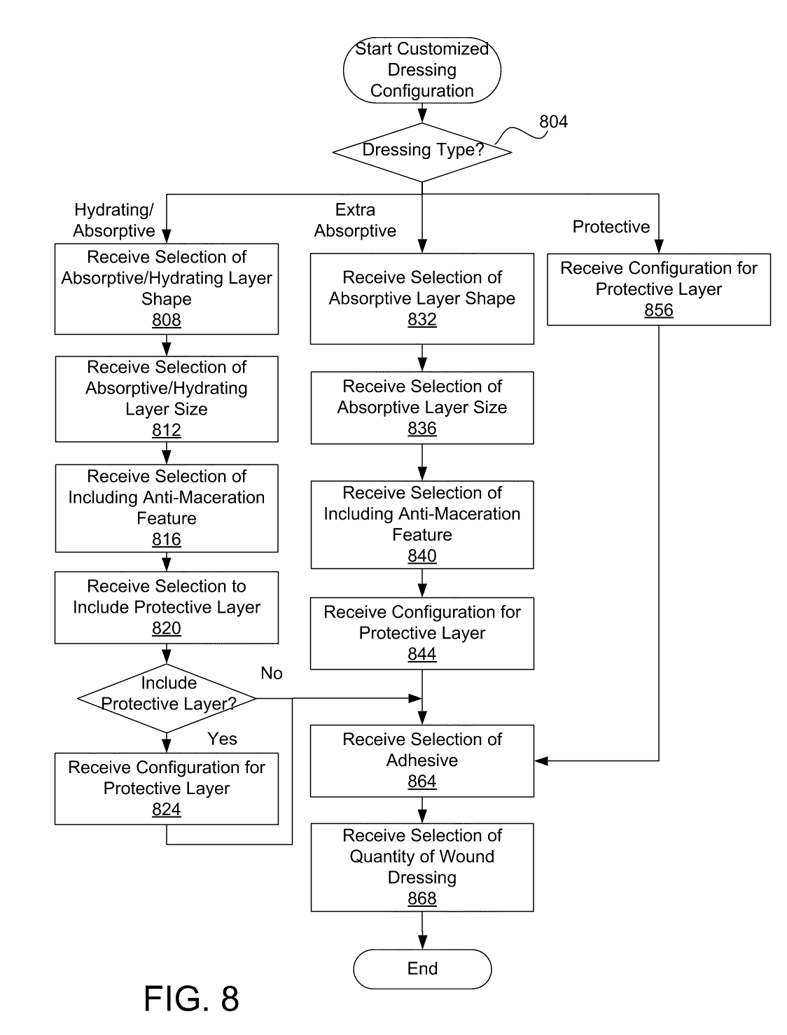

The authorization module 238 is responsible for managing user access privilege to the wound dressing fabricator 120 for the various users in the wound treatment facility 110. The authorization module 238 stores authorization information for one or more users associated with the medical facility 110. Each user is granted an access level for accessing the wound dressing fabricator 120. Each access level provides access to certain features and functionality of the wound dressing fabricator 120. For example, each user is assigned to one or more groups such as an administrator group, a doctor group, and a nurse group. The administrators are given the highest level of access, including the ability to reconfigure setting parameters associated with the wound dressing customization algorithm. The doctors are given access to a standardized and customized dressing configuration mode while some nurses are given access only to a standardized dressing configuration mode, as described below in detail with reference to FIGS. 7 and 8.

The patient and wound information manager 242 is responsible for managing records associated with patients and wounds. The patient and wound information manager 242 generates, updates and retrieves records stored in the patient and wound database 260. The patient and wound database 260 stores for each patient a patient record(s) including, among others, the personal information of the patient, the wound information of the patient, the specifications of wound dressings previously applied to the patient's wounds, treatment history of the patient's wounds, responsible medical practitioners, drugs prescribed to the patient, insurance information of the patient and related medical records of the patient. The database 260 can be accessed to generate reports with respect to any patient, type of wound, treatment, wound dressing, drugs, or the like. The patient and wound information manager 242 also synchronizes the information stored in the patient and wound database with the information in an external medical information system or the facility manager 130. Alternatively, the wound dressing fabricator 120 does not include the patient and wound database 260 but instead communicates with the external medical information system to generate, retrieve and update the information associated with the patients and the wounds.

The dressing customization module 246 includes a wound dressing customization algorithm responsible for generating the specification of a wound dressing based on the user inputs received via the input device 210. The dressing customization module 246 presents options associated with the customization of the wound dressing to the user on the display screen 220. Based on the user's selections, the wound dressing customization algorithm generates a wound dressing specification of the customized wound dressing. The dressing configuration module 246 may also store setting parameters referenced by the wound dressing customization algorithm to present options to the user or to generate the wound dressing specification. The wound dressing specification is sent to the wound dressing fabrication module 280 to fabricate the customized wound dressing. The wound dressing specification may also be stored in the patient and wound database 260 in association with the patient for whom the wound dressing is being fabricated.

The wound dressing specification includes a set of parameters needed for fabricating the wound dressing. At least one of the parameters is generated by the wound dressing algorithm with or without referencing the setting parameters. The wound dressing specification may also include one or more parameters selected or provided by the user. The number and types of parameters generated by the wound dressing algorithm differs depending on the configuration mode or the access level of the users. The wound dressing specification is translated by the wound dressing fabrication module 280 into process sequences and codes for actuators to fabricate the wound dressing.

The maintenance/administration module 252 provides various maintenance and administrative support associated with wound dressing fabrication. One administrative function provided by maintenance/administration module 252 is the allocation of wound dressing fabrication tasks among a plurality of the wound dressing fabricators 120A through 120N. Each wound dressing fabricator 120 maintains a queue of wound dressings that are to be allocated; and for each wound dressing, the maintenance/administration module 252 estimates the amount of time needed for fabricating the wound dressing based on the wound specification. For example, a wound dressing fabricator 120 may have 30 wound dressings queued for fabrication with an estimated total completion time of 1 hour. The maintenance/administration module 252 stores a time limit for the fabrication time at any (or each) wound dressing fabricator 120. If a wound dressing fabricator (for example, the wound dressing fabricator 120A) has a number of queued wound dressings for fabrication and the expected time before fabricating all the wound dressings in the queue exceeds time limit, the maintenance/administration module 252 transmits a request to the facility manager 130. Also, when the wound dressing fabricator 120A has exhausted, or is about to exhaust materials needed to fabricate a certain type of wound dressing, the maintenance/ administration module 252 transmits a request to the facility manager 130 to select another wound dressing fabricator (for example, the wound dressing fabricators 120B through 120N) to fabricate the wound dressing. In response to the request, the facility manager 130 identifies an alternative wound dressing fabricator based on one or more factors (for example, the amount of materials remaining in the wound dressing fabricators, the location of the wound dressing fabricators, and the number of wound dressings in queue for fabrication) and routes one or more of the fabrication requests to the identified wound dressing fabricator.

The maintenance/administration module 252 may also retrieve user information from the facility manager 130 and update the authorization information of the wound dressing fabricator 120. Other functions that may be performed by the maintenance/administration module 252 include, among others, generating reports for auditing, and alerting the administrative user to replace parts in the wound dressing fabricator 120.

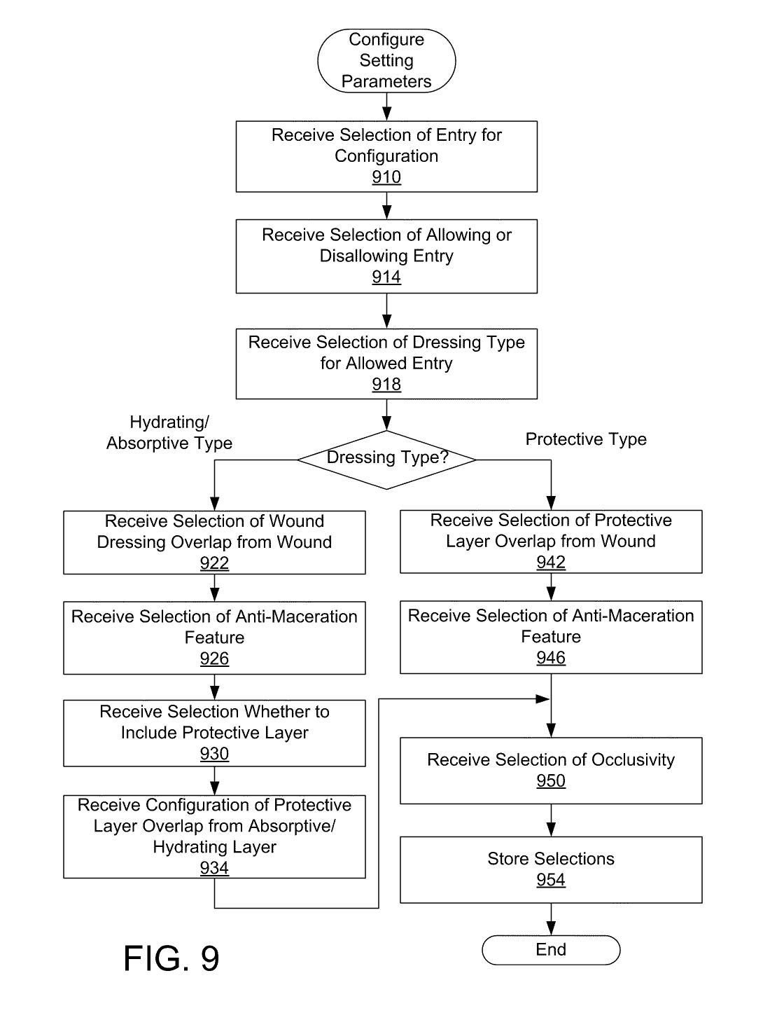

The support module 256 functions in conjunction with the dressing customization module 246 to update or report the wound dressing customization algorithm to the facility manager 130. The support module 256 fetches the wound dressing customization algorithm or its setting parameters from the facility manager 130 and store code for the wound dressing customization algorithm or the setting parameters in the dressing customization module 246. Alternatively, the support module 256 generates and updates the wound dressing customization algorithm or the setting parameters in the dressing customization module 246 based on the user inputs received via the input device 210, as described below in detail with reference to FIG. 9. The support module 256 also sends the updated wound dressing customization algorithm or its setting parameters to the facility manager 130 via the communication module 250 to propagate the wound dressing customization algorithm or its setting parameters to other wound dressing fabricators 120.

The wound dressing fabricator module 280 includes actuators and control devices for fabricating the wound dressing, for example, as described in U.S. patent application Ser. No. 10/431,888 entitled “Method for Treating Wound, Dressing for Use Therewith and Apparatus and System for Fabricating Dressing,” filed on May 7, 2003, which is incorporated by reference herein in its entirety. The wound dressing fabricated at the wound dressing fabrication module 280 is then provided to the user for application to the wound.

The resource tracker 290 monitors the wound dressing fabrication module 280 to track the remaining materials for fabricating the wound dressing. As set forth above, the maintenance/administration module 252 receives information about the materials remaining in the wound dressing fabrication module 280. If the resource tracker 290 sends a signal to the maintenance/administration module 252 that the level of the remaining material is below a threshold, the maintenance/administration module 252 may issue alerts to maintenance personnel to replenish the materials.

The communication module 250 is responsible for communicating with the facility manager 130 via various wireless or a wired communication protocols.

FIG. 3 is a perspective view of a wound dressing fabricator 120 according to one embodiment. The wound dressing fabricator 120 includes, among others, a touch screen 322, an on/off switch 324, a safety switch 325 and wheels 329 for mobility. The wound dressing fabricator 120 may receive inputs related to patient information and the wound characteristics via the touch screen 322, a retractable keyboard 327 (illustrated in FIG. 3 in a retracted state) and/or a diagnostic device coupled to the wound dressing fabricator 120 via a wireless or wired connection (not shown). The wound dressing fabricator 120 also includes a wound dressing fabrication module 334, a cartridge holders 338, 344, a slot 326 for dispensing fabricated dressings into a wound dressing out tray 342, and a computing device embodying the wound dressing manager 230 and a patient/wound database 260. The cartridge holder 338, 344 stores consumable cartridges, each storing materials for fabricating customized wound dressings. The cartridges may be replaced or refilled when the materials stored in the cartridges are depleted. The wound dressing fabrication module 334 may be opened by lifting a handle 328 to replace consumable cartridges.

### Wound Dressing Customization

The dressing customization module 246 presents the user with options with respect to customization of the wound dressing and receives the user's inputs on selected options. The dressing customization module 246 is configured to implement a rule-based wound dressing customization algorithm for customizing the wound dressing. The wound dressing customization algorithm may operate in a standardized configuration mode and an customized configuration mode where different options are presented to the user. In the standardized configuration mode, the wound dressing customization algorithm references the setting parameters to select options to be presented to the user and to generate the wound dressing specification. The setting parameters include various default values to be used by the wound dressing customization algorithm. In the customized configuration mode, the users provide most of all of the parameters for the fabrication of the wound dressing. The wound dressing configuration algorithm does not reference the setting parameters or references only few parameters in the customized configuration mode. The advanced users (e.g., doctors) may be given the option of using the standardized configuration mode or the customized configuration mode.

In both the standardized configuration mode and the customized configuration mode, the dressing customization module 246 guides the users through a specific workflow to select parameters of the wound dressing based on rules according to the protocol employed by the wound treatment facility 110. The types and number of parameters to be set by the user can differ based on the user's access level as well as the configuration mode. Advanced users or users with a high access level may be presented with options for additional parameters not presented to unskilled users or users with a low access level. For example, options to use the customized configuration mode, options to configure a protective layer, and options to configure adhesives may be reserved only for the advanced users.

The wound dressing customization algorithm in the dressing customization module 246 may be generated or updated manually by setting the parameters, as described below in detail with reference to FIG. 9. The setting parameter may be generated or updated manually by an administrator or received from the wound treatment evaluator 140 that automatically generates the setting parameters using statistical tools, as described below in detail with reference to FIG. 5. Alternatively, the wound dressing customization algorithm itself may be received or updated automatically by the facility manager 130 or the wound treatment evaluator 140. The wound dressing customization algorithm and its setting parameters need not be static and can evolve over time as statistical data accumulates or new wound dressing materials become available.

### Architecture of Facility Manager

The facility manager 130 is responsible for (i) coordinating the operation of the multiple wound dressing fabricators 120 installed in the same wound treatment facility 110, (ii) communicating with the wound treatment evaluator 140, and (iii) propagating the protocol to the wound dressing fabricators. The facility manager 130 may be implemented on various types of devices with computing capabilities, including a general purpose computer, another wound dressing fabricator and a wound dressing parameter generator.

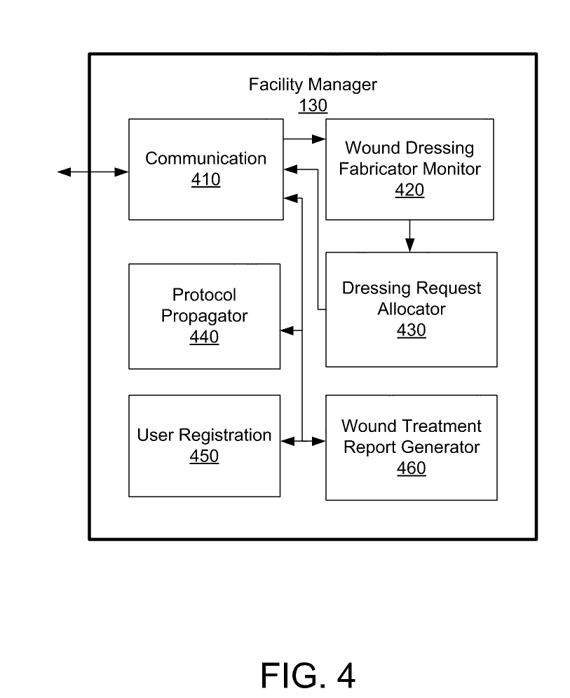

FIG. 4 is a region diagram illustrating a facility manager 130 of FIG. 1, according to one embodiment. The facility manager 130 includes a communication module 410, a wound dressing fabricator monitor 420, a dressing request allocator 430, a protocol propagator 440, a user registration module 450 and a wound treatment report generator 460. One or more of these components, in conjunction with other components, may be implemented in the form of hardware, firmware, software, or any combinations thereof.

The communication module 410 communicates with the wound dressing fabricators 120 and the wound treatment evaluator 140 using any wireless or wired communication protocol, or combination thereof, such as TCP/IP over Ethernet (IEEE 802.3) or IEEE 802.11.

The wound dressing fabricator monitor 420 determines the operational status of the wound dressing fabricators 120 based on information received via the communication module 410. The monitored operational status of each wound dressing fabricator 120 includes the number of wound dressings queued for fabrication, the total amount of time needed for fabricating the queued wound dressings, the remaining materials for fabricating the wound dressings, and whether the fabricator is idle, active, or malfunctioning. The wound dressing fabricator monitor 420 allows a centralized maintenance and administration of multiple wound dressing fabricators 120 installed in the facility 110.

The dressing request allocator 430 coordinates the request for wound dressing fabrication received at one wound dressing fabricator 120 to be allocated to another wound dressing fabricator. If a wound dressing fabricator 120 receives an excessive number of requests for wound dressing fabrication, an excessive amount of time may be needed to fabricate all the wound dressings. The dressing request allocator 430 collects the operational status of the wound dressing fabricators 120 including the excessive number of requests pending before the wound dressing fabricator and redistributes the wound dressing fabrication among the wound dressing fabricators based on factors such as the amount of materials remaining in the wound dressing fabricators, the location of the wound dressing fabricators, and the number of wound dressings in queue for fabrication.

The protocol propagator 440 receives the wound dressing customization algorithm or its setting parameters, and sends the data to the wound dressing fabricators 120 within the same facility 110. The wound dressing customization algorithm in conjunction with its setting parameters indicates the policy or rules to be implemented by the dressing customization module 246. The wound dressing customization algorithm or its setting parameters are sent to the wound dressing fabricators 120 directly or via the wound treatment evaluator 140, as described below in detail with reference to FIG. 5. The wound dressing fabricators 120 receiving the wound dressing customization algorithm or its setting parameters update their dressing customization modules 246. The rule propagator 440 allows the same wound dressing customization algorithm to be used across a plurality of wound dressing fabricators 120 without manually updating each wound dressing fabricator 120 individually.

The user registration module 450 manages the users of the wound dressing fabricators 120 within the wound treatment facility 110. An administrator sets the users to access the wound dressing fabricator 120 and the access level of each user. The information on the users and the access level is stored in the user registration module 450 and propagated to the wound dressing fabricators 120. Alternatively, the users and the access level of the users are retrieved from an electronic medical information system separate from the facility manager 130.

The wound treatment report generator 460 generates the wound treatment reports based on the information collected from the wound dressing fabricators 120. The wound treatment reports are generated by combining the specifications of the wound dressing applied to the wound(s) and the results of the wound treatment. The wound treatment reports may also include information of the wound dressing specifications generated in the customized configuration mode. The wound treatment reports also include statistics such as counts of wound dressings fabricated with certain parameters, and healing progress associated with treating the wound using certain types of wound dressings.

### Architecture of Wound Treatment Evaluator

Each wound treatment facility 110 may employ different clinical protocols for treating the wounds. The wound treatment evaluator 140 collects wound treatment reports from participating wound treatment facilities 110 and evaluates the efficacy of the protocols or practices used. Based on the evaluation, the wound treatment evaluator 140 recommends an improved protocols or practices for customizing the wound dressings. The improved protocols or practices may be translated into the wound dressing customization algorithm or its setting parameters for execution by the dressing customization module 246 of the wound dressing fabricator 120. Each wound treatment facility 110 may test variations of protocol or practices and collect the results of treatments using such varied protocols or practices to evolve the protocol or practices. In this way, the wound treatment facilities 110 collectively develop improved protocol or protocols for treating the wounds.

FIG. 5 is a region diagram illustrating a wound treatment evaluator 140, according to one embodiment. The wound treatment evaluator 140 includes, among other components, a communication module 510, an information collector 520, a report database 530, a wound treatment analyzer 540, and a rule updater 550. One or more of these components, in conjunction with other components, may be implemented in the form of hardware, firmware, software, or any combinations thereof.

The communication module 510 communicates with the facility managers 130. The communication module 510 uses any communication protocols or combination thereof, such as TCP/IP over Ethernet (IEEE 802.3) or IEEE 802.11.

The information collector 520 coordinates communication with the facility manager 130 to collect the wound treatment reports. The collected wound treatment reports are stored in the report database 530.

The wound treatment analyzer 540 analyzes the wound treatment reports stored in the report database 530 using various statistical tools. The condition of the wounds after treatment with customized wounds dressings are evaluated, collected and forwarded to the wound treatment analyzer 450. The wound treatment analyzer 540 classifies wounds into a plurality of categories (e.g., types and dimensions of wounds, and conditions of the wounds).

The wound treatment analyzer 540 then compare an average healing time for treating the wounds for a category of wound by different protocols employed in the wound treatment facilities 110. For each category of wound, the protocol with the best treatment results under predetermined criteria (e.g., the healing time or the lowest overall cost) is then selected using statistical tools such as analysis of variance (ANOVA) or Excel statistical analysis packages. The best practices for each category of wounds are then combined and translated into the wound dressing customization algorithm or its setting parameters. The wound treatment analyzer 540 to evaluate various parameters for customizing the wound dressings.

The wound dressing customization algorithm or its setting parameters generated by the wound treatment analyzer 540 is sent to the rule updater 550. The rule updater 550 then sends the updated wound dressing customization algorithm to the dressing customization module 246 of the wound dressing fabricators 120 in participating wound treatment facilities 110. Further, participating wound treatment facilities 110 may be provided with different clinical protocols to test statistical significance of one or more parameters in the wound dressing customization, and use the collected information in a next cycle to generate an improved wound dressing customization algorithm.

### Method of Customizing and Fabricating Wound Dressings

FIG. 6 is a flow chart illustrating a method of fabricating a customized wound dressing, according to one embodiment. First, the user logs 614 into the wound dressing fabricator 120. The login information received through the input device 210 of the wound dressing fabricator 120 is processed by the authorization module 238 to determine whether the user is authorized to use the wound dressing fabricator 120 and the level of access granted to the user. An example of user login interface is illustrated in FIG. 10. In the example of FIG. 10, a list of eligible users is displayed in the upper portion 1010 of the user interface 1004. A virtual keyboard 1020 is provided at the lower portion of the user interface 1004 to receive passwords associated with the user. After entering the password, the user can press a “log in” button 1030 to start the process of wound dressing customization and fabrication.

Referring again to FIG. 6, the wound dressing fabricator 120 receives 618 the user's selection of the patient for whom the wound dressing is to be fabricated. FIG. 11 is user interface 1104 associated with selecting a patient for the current customization session of the wound dressing fabricator 120, according to one embodiment. The user provides the name of the patient or the patient identification (ID) in a text button 1120 using the virtual keyboard 1320. The patient and wound information manager 242 retrieves the patient information from the patient and wound database 260 and displays the information on the upper portion 1110 of the user interface 1104.

Referring again to FIG. 6, the wound dressing fabricator 120 next receives 626 the user's selection of the wound or information of the wound for which the wound dressing is to be fabricated. The wound is selected, for example, using a graphical user interface as described with reference to FIGS. 13 through 16. FIG. 13 is a user interface 1304 displaying the wounds of the selected patients, according to one embodiment. After a patient is selected, the wounds of the selected patient are presented to the user in the form of virtual wound cards (alternatively, tabs) 1312 through 1322. Each wound card includes details about each wound including, for example, the current dimension of the wound, previous dimensions of the wound, the type of wound dressing previously applied, and the dates when the wound dressings were applied. The user obtains detailed information of the wound by selecting the virtual wound cards 1312 through 1322 corresponding to the wound. The user can press “New Dressing” button 1370 to start customizing of the wound dressing for the wound identified in the virtual wound card 1322.

The user interface 1304 also displays a wait time window 1350 and a resource window 1340. The wait time window 1350 displays the wait time and pending wound dressings for fabrication in the wound dressing fabricator 120. The resource window 1340 displays remaining materials for fabricating wound dressings, as determined by the resource tracker 290.

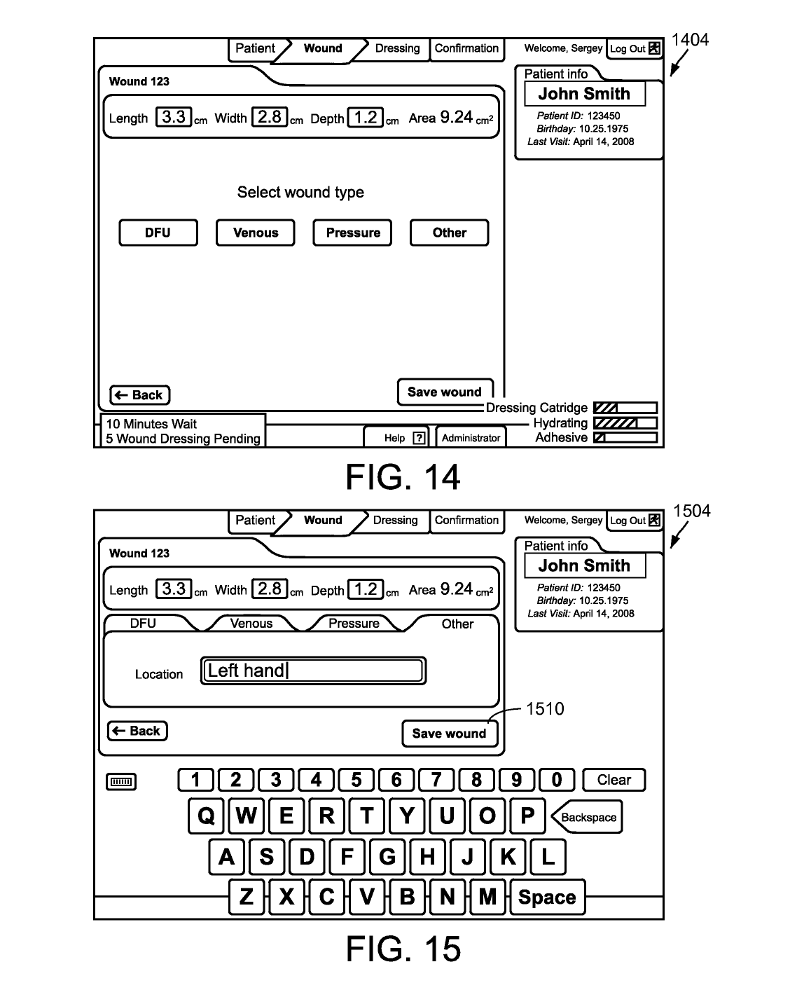

FIG. 14 is a user interface 1404 associated with adding information about a new wound, according to one embodiment. After the “add new wound card” button 1660 in FIG. 13 is pressed, the user is presented with options related to the type of wound as illustrated in FIG. 14. Four categories of wound type are presented in the example of FIG. 14: diabetic foot ulcer (DFU), venous, pressure, and other. The categories of wound type presented are be modified based on the patient information stored in the patient and wound database 260. For example, if the patient is not diagnosed with diabetes, the first category of DFU may be omitted from the types of wound presented to the user.

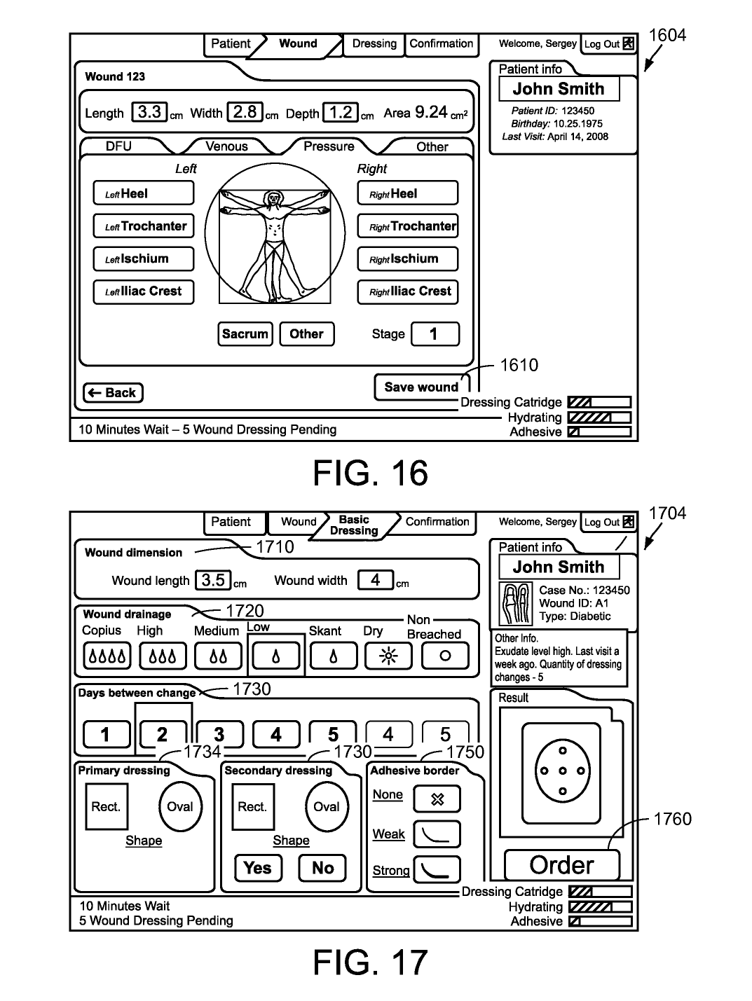

Parameters associated with the new wound are entered after selecting to create a virtual wound card. FIG. 15 illustrates an example user interface 1504 for entering the location of the new wound classified as being “other” type of wound. After identifying the location of the wound, a “save wound” button 1510 may be pressed to store the information of the new wound. Similarly, FIG. 16 illustrates a user interface 1604 for providing information related to a pressure wound. The user identifies the location of the wound by pressing one of the buttons representing the location of the wound. After identifying the location of the wound, a “save wound” button 1610 is pressed to store the information of the new wound.

Referring again to FIG. 6, the wound dressing for the selected wound is then customized 630 by setting one or more parameters associated with the wound dressing. The wound dressing is customized by the dressing customization module 246 in the wound dressing fabricator 120, as described below in detail with reference to FIGS. 7 and 8. The types and numbers of parameters that the user may adjust depend on the access level of the users and the configuration mode (i.e., the standardized mode and the customized mode).

The specification of the wound dressing is presented to the user for confirmation 632. A wound dressing specification is generated after the specification of the wound dressing is confirmed. FIG. 19 illustrates a user interface 1904 for receiving confirmation from the user, according to one embodiment. The customized wound dressing is illustrated in the right side 1910 of the user interface 1904. The user may also select the quantity of wound dressing to be fabricated by typing in a number in region 1920. As described below in detail with reference to FIG. 7, configurations of a plurality of wound dressings may be illustrated in the area 1910 when more than one wound dressing is selected for fabrication. The customized wound dressing may then be placed in a queue for fabrication by pressing a “fabricate” button 1930.

Referring again to FIG. 6, the customized wound dressing is then fabricated 634 at the wound dressing fabrication module 280 according to the wound dressing specification.

The patient and wound information in the patient and wound database 260 is updated 638 to reflect the newly fabricated wound dressing. Then the process for customizing and fabricating the wound dressing ends.

Certain steps may be omitted or added to the method of customization and fabricating the wound dressing. Also, additional steps (e.g., receiving inputs from diagnostic devices) may be added.

FIG. 7 is a flow chart illustrating a method of customizing a wound dressing in the standardized configuration mode of the wound dressing customization algorithm, according to one embodiment. In the standardized configuration mode, limited numbers of options are presented to the user for selection. In the standardized configuration mode, most of the wound dressing parameters are set according to the default values as defined in the setting parameters.

The dimension of the wound (e.g., lengths, widths, and depths) is then received 710. The level of exudate from the wound is then received 714. The time interval between the changes of wound dressings is received 718. The time interval is, for example, in the units of hours or days. The parameters of protective layer are then received 726. The parameters of the protective layer include, among others, whether to provide the protective layer, the shape of the protective layer, the size of the protective layer, the overlap between the protective layer and an absorptive/hydrating layer, and the occlusivity of the protective layer. The protocol 340 may automatically select one or more parameters associated with the protective layer. The parameters of adhesive are also received 730. The parameters associated with the adhesive include, for example, the strength of adhesive and specific adhesive materials to be used in the wound dressing. One or more of these steps are optional and may be omitted. For example, receiving 726 configuration of protective layer and/or receiving 730 of the configuration of an additive may be omitted. In this case, the quatity of wound dressing is received after receiving 718 the interval for changing the wound dressing.

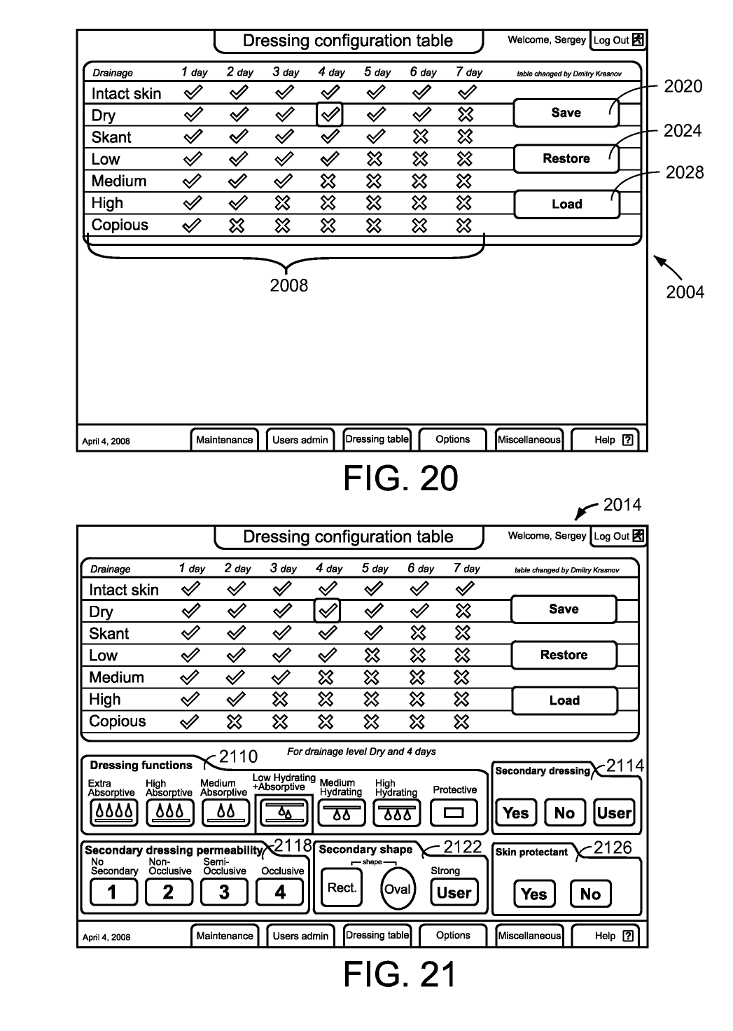

FIG. 17 illustrates a user interface 1704 associated with customization of a wound dressing in the standardized mode, according to one embodiment. The current dimension of the wound is provided in region 1710, followed by setting of the level of exudate in region 1720, the interval for changing the wound dressings in region 1730, the shape of the hydrating/absorptive layer (i.e., primary dressing) in region 1734, selection to use (“yes” or “no”) a protective layer (i.e., secondary dressing) and the shape of the protective layer (“rectangular” or “oval”) in region 1740, and the strength of the adhesive in region 1750. In the example of FIG. 17, the maximum interval before changing to a new wound dressing is set to 5 days when low exudate is chosen in region 1720. The regions for 6 days and 7 days are faded out and cannot be selected by the user. Whether the combinations of the level of exudate and the time interval between the wound dressings are allowed is defined in the setting parameters, which may be configured the dressing customization table as described below in detail with reference to FIG. 20.

If two or more wound dressings are fabricated in a fabrication session, each wound dressing may vary based on predicted the progress of wounds. The wound progression model indicates how the wound progresses over time. The wound dressings suitable for the wound at the time of change are predicted by the wound progression module and the wound dressing according to the model is fabricated.

Also, a dressing progression model may be used to predict the changes in the wound dressing properties between the time the dressing is fabricated and the dressing is applied to the wound. The properties may change with progress of time and the storage or shipping conditions of the wound dressing. The dressing progression module may allow prediction of the following changes in the dressing parameters: (a) hydration level of a wound dressing that changes due to evaporation and/or loss through packaging, (b) redistribution of fluid or flowable drugs inside dressing due to diffusion or capillary forces; and (c) changes to antimicrobial additives or drugs due to oxidation or exposure to certain temperatures.

After receiving the parameters associated with the customization of the wound dressing, the wound dressing fabricator 120 (specifically, the dressing customization module 246) generates the wound dressing specification based on the user inputs.

To configure certain parameters associated with the wound dressing, extensive knowledge or experiences may be required. Therefore, a group of users (e.g., doctors) may be allowed to choose certain parameters while others (e.g., nurses) are not. As illustrated in FIG. 7, the steps with “AL Check” arrows indicate that only advanced users are allowed to provide parameters for these steps. Specifically, in the example of FIG. 7, only advanced users are allowed to set parameters associated with the protective layer, the configuration of the adhesive and the quantity of the wound dressings while default parameters are selected automatically for inexperienced or untrained users.

In the standardized dressing customization mode, options associated with the wound dressing are provided in a systematic workflow as illustrated in FIG. 7 to reduce confusion on the part of the user. The rule-based customization also reduces user inputs needed for customizing the wound dressing. In this way, the likelihood of providing incorrect user inputs associated with the customization of the wound dressings is reduced, which reduces the fabrication of flawed wound dressings for both advanced users and inexperienced users alike.

FIG. 8 is a flow chart illustrating a method of customizing a wound dressing in a customized mode, according to one embodiment. First, the type of wound dressing is selected 804. In the example of FIG. 8, the user selects one dressing type among the three types of wounds dressings: (i) a hydrating/absorptive type, (ii) an extra absorptive type, and (iii) a protective type. The classification of hydrating/absorptive type, extra absorptive type, and protective type is merely illustrative and different classification may also be used.

For the hydrating/absorptive type of wound dressing, the selection of absorptive/hydrating layer shape is received 808. The size of the absorptive/hydrating layer is then received 812 at the wound dressing fabricator 120. The selection of including an anti-maceration feature is then received 816 at the wound dressing fabricator 120. Further, the selection to include a protective layer is received 820 at the wound dressing fabricator 120. If it is determined that the protective layer is to be included, the configuration of the protective layer is received 824 at the wound dressing fabricator 120. Then the process proceeds to receive 864 the selection of adhesive for the wound dressing. If it is determined that the protective layer is not to be provided on the wound dressing, then the step 824 of receiving the configuration of the protective layer is omitted and the process proceeds directly to receiving 864 the selection of the adhesive. The process of customizing the wound dressing ends after receiving 868 the quantity of wound dressing.

For an extra absorptive type of wound dressing, the selection of the shape of an absorptive layer is received 832 at the wound dressing fabricator 120. Then the size of the absorptive layer is received 836. The selection for an option to include an anti-maceration feature in the wound dressing is then received 840 at the wound dressing fabricator 120. A protective layer is always provided for the extra absorptive type. Accordingly, the configuration of the protective layer is received 844 at the wound dressing fabricator 120. The selection of the adhesive is also received 864. The process of customizing the wound dressing ends after receiving 868 the quantity of wound dressing.

For a protective type wound dressing, the configuration of the protective layer (e.g. the degree of occlusiveness) is received 856. Then the selection of adhesive is received 864 at the wound dressing fabricator 120. The process of customizing the wound dressing ends after receiving 868 the quantity of wound dressing.

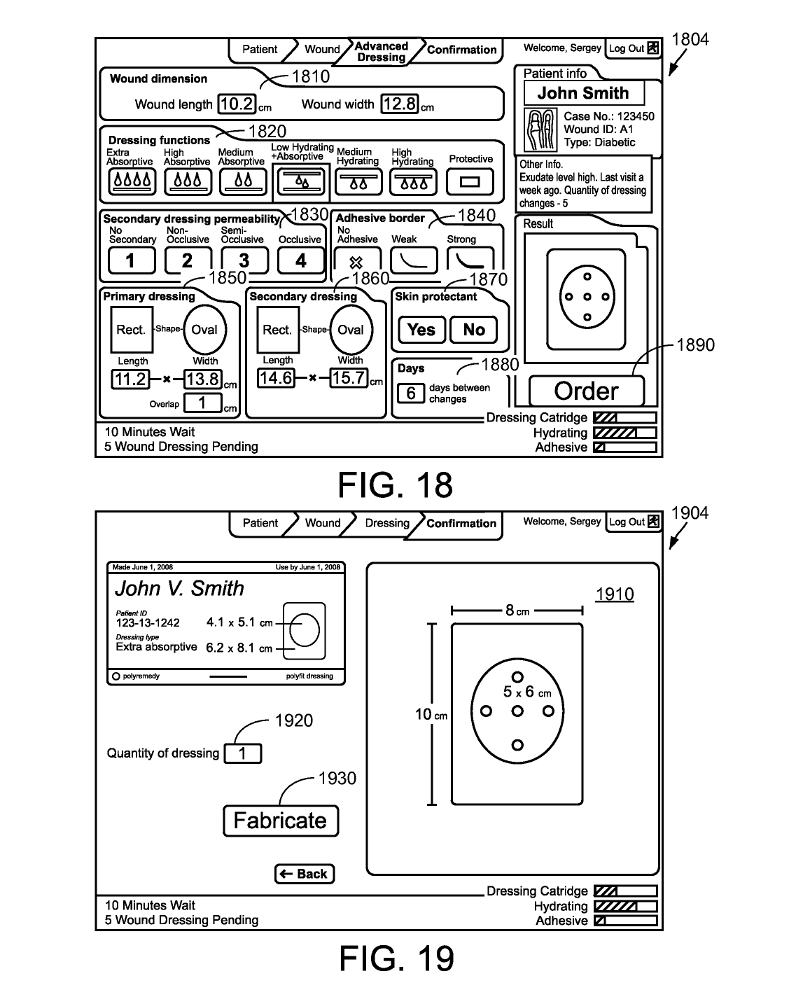

FIG. 18 illustrates a user interface 1804 for customizing a wound dressing in the customized mode, according to one embodiment. The wound in the example of FIG. 18 is indicated in region 1810 as having the length of 10.2 cm and the width of 12.8 cm. The dressing type of “low hydrating and absorptive” is selected in region 1820, and other parameters associated with this selection are shown in regions 1830 through 1860. As shown in region 1830, the user may choose not to include the protective layer by choosing “no secondary.” Otherwise, the user needs to choose one among three options of occlusivity in region 1830 (non-occlusive, semi-occlusive, and occlusive).

As shown in region 1850, the absorptive/hydrating layer (i.e., primary dressing) in this example may be customized into one of two shapes: (i) rectangular and (ii) oval. The length of the absorptive/hydrating layer is set to 11.2 cm and the width is set to 13.8 cm. As shown in region 1860, the protective layer (i.e., secondary dressing) may also be customized into one of two shapes: (i) rectangular and (ii) oval. The length of the protective layer is set to 14.6 cm and the width is set to 15.7 cm. The anti-maceration feature (i.e., skin protectant) is disabled as shown in region 1870. In region 1880, the user may choose the interval for changing the wound dressing. In the example of FIG. 18, the interval is set to six days. After selecting all options in the user interface 1804, the user may press “order” button 190 to proceed to a confirmation user interface 1904, as described above in detail with reference to FIG. 19.

### Setting of Protocol for Customizing Wound Dressing

FIG. 9 is a flow chart illustrating a method of manually configuration the setting parameters of the wound dressing customization algorithm, according to one embodiment. The setting parameters are stored in the dressing customization module 246 and are referenced by the wound dressing customization algorithm when presenting options to the user in the standardized dressing configuration mode or when generating the wound dressing specification. The setting parameters of the wound dressing customization algorithm may be selected manually by an authorized user. Alternatively, the setting parameters may be received from the wound treatment evaluator 140, as described above with reference to FIG. 5.

After the process of manually setting the parameters starts, selection of an entry for setting is received 910 at the wound dressing fabricator 120. Then a user input is received 914 to toggle between allowing or disallowing the combination of exudate (drainage) and interval of change (days).

For an allowed entry, the selection of dressing type is received 918 at the wound dressing fabricator 120. Different sets of parameters may be needed for configuring the wound dressing depending on the type of wound dressing. For hydrating and absorptive type wound dressings, the selection of wound dressing overlap from wound is received 922. Further, selection as to including an anti-maceration feature is received 926. Then selection as to include a protective layer in the hydrating/absorptive type of wound dressings is received 930. If the protective layer is to be included, the configuration of the protective layer overlap with the absorptive or hydrating layer is received 934. The selection of occlusivity of the wound dressing is also received 950. The received selection of parameters for the hydrating/absorptive wound dressing is then stored 954.

If the wound dressing is a protective type, selection of protective layer overlap from a wound is received 942. Further, the selection of anti-maceration feature is received 946. As in the hydrating/absorptive type wound dressing, the selection of occlusivity of the protective layer is received 950 at the wound dressing fabricator 120. The received selection of parameters for the protective wound dressing is then stored 954.

FIG. 20 illustrates a user interface 2004 displaying a table 2008 for configuring the setting parameters, according to one embodiment. The table 2008 of FIG. 21 is indicated in region 2110 as having the length of 10.2 cm and the width of 12.8 cm. The dressing type of “low hydrating and absorptive” is selected in region 2120, and other parameters associated with this selection are shown in blocks 2130 through 2160. As shown in region 2130, the user may choose not to include the protective layer by choosing “no secondary.” Otherwise, the user needs to choose one among three selections of occlusivity in region 2130 (non-occlusive, semi-occlusive, and occlusive). As shown in block 2150, the absorptive/hydrating layer (i.e., primary dressing) in this example is customized into one of two shapes: (i) rectangular and (ii) oval. The length of the absorptive/hydrating layer is set to 11.2 cm and the width is set to 13.8 cm. As shown in block 2160, the protective layer (i.e., secondary dressing) is also customized into one of two shapes: (i) rectangular and (ii) oval. The length of the protective layer is set to 14.6 cm and the width is set to 15.7 cm. The anti-maceration feature (i.e., skin protectant) is disabled as shown in block 2170. In block 2180, the user chooses the interval for changing the wound dressing. In the example of FIG. 21, the interval is set to six days. After selecting all options in the user interface view 2104, the user presses “order” button 2190 to proceed to a confirmation user interface view 2204 as described below in detail with reference to FIG. 22.

FIG. 21 illustrates a user interface 2104 for setting an entry in the table of FIG. 20, according to one embodiment. When an allowed entry is selected, the parameters associated with the entry are displayed for setting by the user. In the example of FIG. 2, the parameters are dressing functions (in region 2110), whether to provide a protective layer (“secondary dressing” in region 2114), the occlusivity of the protective layer (in region 2118), the shape of the protective layer (in region 2122), and the anti-maceration feature (in region 2126). Selecting “user” buttons in regions 2114 and 2122 allow the user to manually set the parameters in the customized configuration mode.

### Alternative Embodiments

The wound treatment facilities 110 participating in the development of the protocol 340 may share the developed protocol without any fees. On the other hand, non-participating wound treatment facilities may be required to purchase the protocol 340 with payment of fees. Each wound treatment facility 110 may also develop its own version of the protocol 340 and post the protocol 340 on the wound treatment evaluator. Other wound treatment facilities 110 may license the protocol 340 from the wound treatment facility that developed the protocol 340.

Components of the wound dressing fabricators 120, the facility manager 130, and the wound treatment evaluator 140 may be implemented in software, firmware, hardware or combinations thereof. The components implemented as software may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of customizing and fabricating a wound dressing for a wound of a patient by a wound dressing fabricator, comprising:
receiving a first set of parameters associated with the wound;
generating a wound dressing specification by a wound dressing customization algorithm based on the first set of parameters, the wound dressing specification including a second set of parameters of the wound dressing, the wound dressing customization algorithm implementing a clinical protocol for customizing a wound dressing; and
fabricating a wound dressing according to the wound dressing specification.

2. The computer-implemented method of claim 1, further comprising:
receiving user information of a medical practitioner accessing the wound dressing fabricator; and
determining an access level of the medical practitioner based on the user information.

3. The computer-implemented method of claim 1, further comprising:
storing a result of the wound treatment using the wound dressing;
analyzing the result of the wound treatment and the applied wound dressing by statistical tools;
generating an updated wound dressing customization algorithm based on the analysis; and
storing the updated wound dressing customization algorithm in the wound dressing fabricator.

4. The computer-implemented method of claim 1, further comprising sending a request to fabricate the wound dressing to another wound dressing fabricator responsive to detection of a predetermined event.

5. The computer-implemented method of claim 4, wherein the predetermined event is an amount of time needed to fabricate the wound dressing exceeding a first threshold, a number of wound dressings for fabrication exceeding a second threshold or exhaustion of material needed for fabricating the wound dressing.

6. The computer-implemented method of claim 1, wherein the first set of parameters comprises dimensions of the wound, an exudate level of the wound, a time interval for replacing the wound dressing.

7. The computer-implemented method of claim 1, wherein the first set of parameters comprises a type of the wound dressing, the dressing type comprising at least a hydrating or absorptive type and a protective type, configuration of a primary wound dressing responsive to the dressing type being the hydrating or absorptive type, and configuration of a protective layer responsive to the dressing type being the protective type.

8. The computer-implemented method of claim 1, wherein generating of the wound dressing specification is further based on a wound progression model representing progress of the wound with progress of time and a dressing progression module representing changes in properties of the wound dressing with progress of time.

9. The computer-implemented method of claim 1, further comprising receiving setting parameters reference by the wound dressing customization algorithm to generate the wound dressing specification.

10. The computer-implemented method of claim 9, wherein the setting parameters comprise a selection indicating whether to allow or disallow a time interval between changing of wound dressings for a level of exudate from the wound, a selection of a type of primary material of the wound dressing for the selected combination of the level of exudate and the time interval, and a shape of the selected primary material.

11. A wound dressing fabricator for fabricating a wound dressing customized to a wound of a patient, comprising:
an input device configured to receive a first set of parameters associated with the wound;
a wound dressing manager configured to automatically generate a wound dressing specification by a wound dressing customization algorithm based on first the set of parameters, the wound dressing specification including a second set of parameters of the wound dressing, the wound dressing customization algorithm implementing a clinical protocol for customizing a wound dressing; and
a wound dressing fabrication module for fabricating a wound dressing according to the wound dressing specification.

12. The wound dressing fabricator of claim 11, further comprising an authorization module for determining an access level of a medical practitioner based on user information received via the input device.

13. The wound dressing fabricator of claim 11, further comprising a database for storing a result of the wound treatment using the wound dressing.

14. The wound dressing fabricator of claim 11, further comprising an administrative module configured to send a request to fabricate the wound dressing to another wound dressing fabricator responsive to an amount of time needed to fabricate the wound dressing exceeding a first threshold, a number of wound dressings for fabrication exceeding a second threshold or material needed for fabricating the wound dressing being exhausted.

15. The wound dressing fabricator of claim 11, wherein the first set of parameters comprises a type of the wound, a dimension of the wound, an exudate level of the wound, an interval for replacing the wound dressings, a choice of protective layer, and a choice of adhesive for use in the wound dressing.

16. The wound dressing fabricator of claim 12, wherein the wound dressing manager is adapted to generate the wound dressing specification based further on a wound progression model representing progress of the wound with progress of time and a dressing progression module representing changes in properties of the wound dressing with progress of time.

17. A wound treatment evaluator for generating setting parameters of a wound dressing customization algorithm for automatically customizing a wound dressing adapted to a wound of a patient, the setting parameters referenced by the wound dressing customization algorithm to customize the wound dressing, comprising:
an information collector configured to collect wound treatment reports of customized wound dressings from a plurality of wound dressing fabricators, the wound treatment reports including results of treating wounds by applying the customized wound dressings;
a storage configured to store the collected wound treatment reports; and
a wound treatment analyzer configured to generate the setting parameters by performing statistical analysis on the collected wound treatment reports, the setting parameters sent to one or more wound dressing fabricators to fabricate the wound dressings.

18. The wound treatment evaluator of claim 17, wherein the wound treatment analyzer is further configured to determining a best treatment practice for a category of wounds by comparing results of treating the category of wounds using different wound dressings, the wound treatment analyzer combining best treatment practices for a plurality of categories of wounds to generate the setting parameters.

19. The wound treatment evaluator of claim 18, further comprising a rule updater for propagating the setting parameters to one or more wound dressing fabricators.

20. A computer-readable storage medium storing instructions thereon, the instructions when executed by a processor in a wound dressing fabricator for customizing and fabricating a wound dressing for a wound of a patient, cause the processor to:
receive a first set of parameters associated with the wound;
generate a wound dressing specification by a wound dressing customization algorithm based on the first set of parameters, the wound dressing specification including a second set of parameters of the wound dressing, the wound dressing customization algorithm implementing a clinical protocol for customizing a wound dressing; and
fabricate a wound dressing according to the wound dressing specification.

21. The computer-readable storage medium of claim 20, further comprising instructions to:
receive user information of a medical practitioner accessing the wound dressing fabricator; and
determine an access level of the medical practitioner based on the user information, the access level comprising at least a first access level and a second access level.

22. The computer-readable storage medium of claim 21, further comprising instructions to store a result of the wound treatment using the wound dressing.

23. The computer-readable storage medium of claim 22, further comprising instructions to analyze the result of the wound treatment and the used wound dressing to update the wound dressing customization algorithm.

24. The computer-readable storage medium of claim 23, further comprising instructions to send the updated wound dressing customization algorithm to another wound dressing fabricator.

25. The computer-readable storage medium of claim 26, further comprising instructions to receive setting parameters reference by the wound dressing customization algorithm to generate the wound dressing specification.

26. A method of generating setting parameters of a wound dressing customization algorithm for automatically customizing a wound dressing adapted to a wound of a patient, the setting parameters referenced by the wound dressing customization algorithm in a wound dressing fabricator to customize the wound dressing, the method comprising:
collecting wound treatment reports of customized wound dressings from a plurality of wound dressing fabricators, the wound treatment reports including results of treating wounds by applying the customized wound dressings;
storing the collected wound treatment reports; and
generating the setting parameters by performing statistical analysis on the collected wound treatment reports, the setting parameters sent to one or more wound dressing fabricators to customize and fabricate wound dressings based on the protocol.

27. The method of claim 26, further comprising:
determining a best treatment practice for a category of wounds by comparing results of treating the category of wounds using different wound dressings;
combining best treatment practices for a plurality of categories of wounds to generate the setting parameters; and
sending the setting parameters to one or more wound dressing fabricators to customize and fabricate wound dressings.

28. A computer readable storage medium storing instructions thereon to generate setting parameters of a wound dressing customization algorithm for automatically customizing a wound dressing adapted to a wound of a patient, the setting parameters referenced by the wound dressing customization algorithm in a wound dressing fabricator to customize the wound dressing, the instructions when executed by a processor cause the processor to:
collect wound treatment reports of customized wound dressings from a plurality of wound dressing fabricators, the wound treatment reports including results of treating wounds by applying the customized wound dressings;
store the collected wound treatment reports; and
generate the setting parameters by performing statistical analysis on the collected wound treatment reports, the setting parameters sent to one or more wound dressing fabricators to customize and fabricate wound dressings based on the protocol.

29. The computer readable storage medium of claim 28, further comprising instructions to:
determine a best treatment practice for a category of wounds by comparing results of treating the category of wounds using different wound dressings;
combine best treatment practices for a plurality of categories of wounds to generate the setting parameters; and
send the setting parameters to one or more wound dressing fabricators to customize and fabricate wound dressings.
